(19) United States
(12) Patent Application Publication
(10) Pub. No.: US 2026/0061643 A1
(43) Pub. Date: Mar. 5, 2026

(54) Modular Electric Hair Cutting System Attachments

(71) Applicant: Duett, LLC., Flowood, MS (US)

(72) Inventors: Tyler Albert Anthony, Brandon, MS (US); Thomas Gerard White, Madison, MS (US); Wade Patterson, Huntsville, AL (US); Patrick Stapler, Huntsville, AL (US); Daniel Lipszyc, Las Vegas, NV (US); Stephen Sanford, Bozeman, MT (US); Demri Horton, Bozeman, AL (US)

(73) Assignee: Duett, Flowood, MS (US)

(21) Appl. No.: 18/964,076

(22) Filed: Nov. 29, 2024

Related U.S. Application Data
(63) Continuation-in-part of application No. 17/697,855, filed on Mar. 17, 2022.
Application No. 17/697,855 is a continuation-in-part of application No. 16/418,010, filed on May 21, 2019, now abandoned.
(60) Provisional application No. 62/675,173, filed on May 23, 2018.

(51) Int. Cl. B26B 19/04; B26B 19/28

(52) U.S. Cl. CPC B26B 19/046; B26B 19/28

(57) ABSTRACT

A hair-cutting device of the present disclosure has a housing and a lower shaft protruding from a top surface of the housing, and the lower shaft receives a head. Further, the top surface has pinholes that allow air to exit the housing and strike the head.

### CROSS-REFERENCE TO RELATED APPLICATIONS

This Application claims priority to and is a Continuation-In-Part of U.S. patent Ser. No. 17/697,855 entitled Modular Electric Hair-Cutting Devices and Methods and filed Mar. 17, 2022, which claims priority to U.S. patent application Ser. No. 16/418,010 entitled Modular Electric Hair-Cutting Devices and Methods and filed May 21, 2019, which claims priority to U.S. Provisional Patent Application No. 62/675,173 entitled Modular Electric Hair Cutting System with Autonomous Temperature Control and filed May 23, 2018.

### BACKGROUND

Barbers often use electric hair-cutting devices when cutting an individual's hair. The electric hair-cutting devices typically have a cutting module that comprises a blade. In operation, the hair-cutting devices often heat up rapidly to high temperatures. This often causes the hair-cutting devices to overheat. In this regard, when the hair-cutting devices overheat the barber is unable to sustain all day use without the electric hair-cutting devices becoming excessively hot and overheating. Furthermore, when the hair-cutting devices are in continuous or frequent use, they often fail to sustain a comfortable operating temperature for its motor, enclosure, and consequently its internal components which overheat the device. Note that once the hair-cutting device overheats, the barber is forced to change to a different hair-cutting device.

There exist some solutions that attempt to mitigate blade overheating and keep temperatures within the hair-cutting device enclosure low. For example, some hair-cutting devices use heat-resistant materials for its enclosure. However, these solutions fail to sustain the continuous and/or frequent use which the barber requires. While they do temporarily reduce the discomfort the operator experiences initially, as the device continues to operate its temperature continuously rises. This inevitably causes the device to overheat and forces its operator to switch to another device.

The system is described with reference to the accompanying drawings. In the drawings, like reference numbers indicate identical or functionally similar elements. Additionally, the left-most digit(s) of a reference number identifies the drawing in which the reference number first appears.

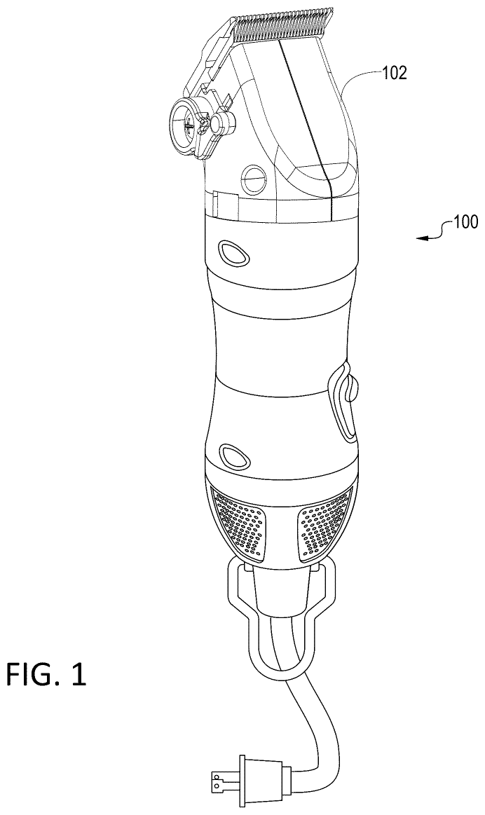

FIG. 1 is a perspective view of an exemplary modular hair-cutting device in accordance with an embodiment of the present disclosure.

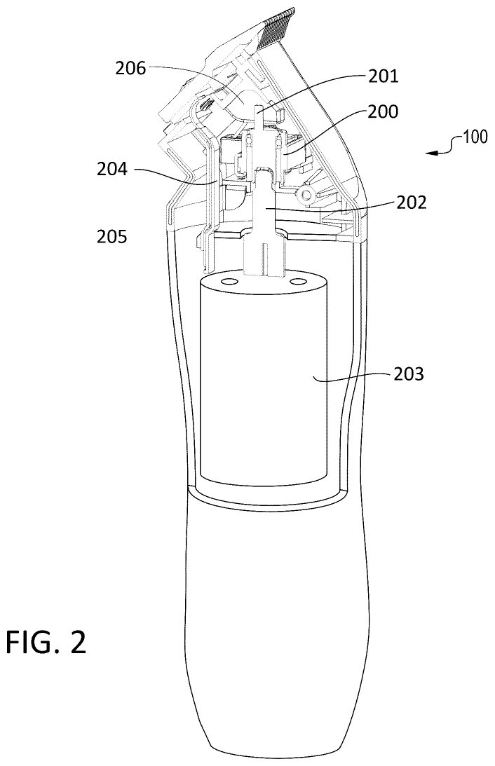

FIG. 2 is a perspective sectional view of the modular hair-cutting device shown in FIG. 1.

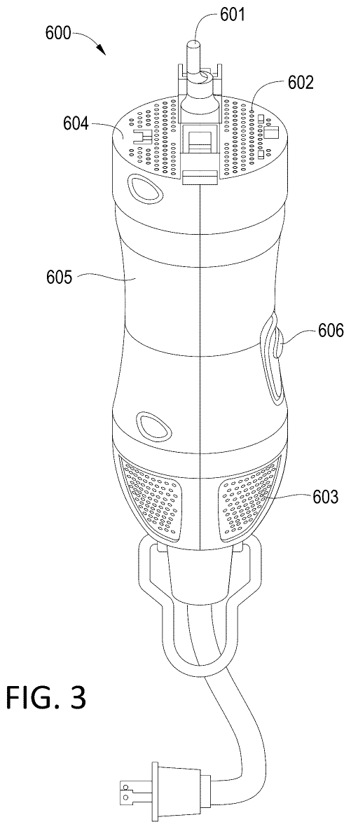

FIG. 3 is a perspective view of a lower housing of the modular hair-cutting device shown in FIG. 1.

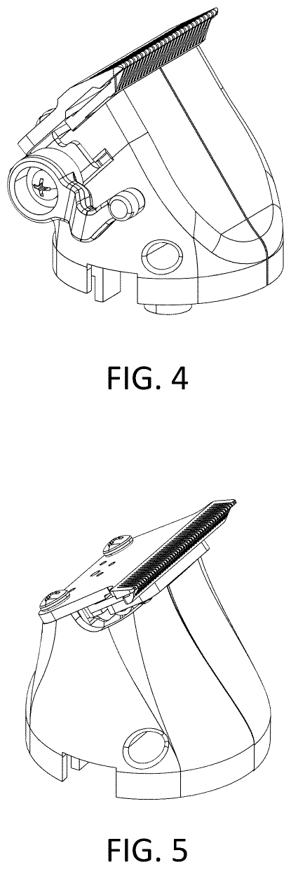

FIG. 4 is a perspective view of an exemplary clipper head for attachment to the modular hair-cutting device shown in FIG. 1.

FIG. 5 is a perspective view of an exemplary trimmer head for attachment to the modular hair-cutting device shown in FIG. 1.

### DETAILED DESCRIPTION

The electric hair-cutting and/or fur-cutting device of the present disclosure at a barber's workstation barber and/or their clients do not feel the discomfort as an electric hair cutting device overheats. In one embodiment, the electric hair-cutting device is modular taking both the form and function of whichever device the barber requires. For example, a head of the hair-cutting device has an interchangeable head so that the hair-cutting device my serve as a clipper, a trimmer, or shaver during the course of cutting a client's hair. In one embodiment the electric hair-cutting device does not have to be modular. In such an embodiment, the electric hair-cutting device is module. That is the head may be removeable from the body so that other different heads may be used.

Therefore, the hair-cutting device of the present disclosure provides a single electric hair-cutting device capable of functioning as a clipper, a trimmer, or a shaver and autonomously maintains a predetermined temperature while its cutting elements are active and/or inactive.

Note that while the modular hair-cutting device may be used on human hair; however, the modular hair-cutting device may also be used on fur, such as animal fur.

FIG. 1 is a perspective view of a hair-cutting device 100 in accordance with an embodiment of the present disclosure. The hair-cutting device 100 comprises a lower housing 121. The lower housing 121 is shaped so that it may be easily gripped by a user. In this regard, the lower housing 121 is contoured for grasping.

The hair-cutting device 100 is electric. Thus, the hair-cutting device 100 comprises a power cord 120 that extends from the lower housing 121 of the hair-cutting device 100 to a wall power receptacle. In one embodiment, the cord may be a swivel cord that prevents the cord from bending and/or causing component damage.

The hair-cutting device 100 comprises a head 102. The cutting head 102 is interchangeable. In this regard, the head 102 may be removed so that other, different types of heads may be coupled to the lower housing 121. A clipping head is shown in FIG. 1; however, other heads are possible, as described herein. The head 102 also comprises a latch mechanism 105 so that the head 102 may be removed from the lower housing 121. Once removed, a clipper head (not shown), a trimmer head (not shown), or a shaver head (not shown) may be used. This enables more versatile use of the hair-cutting device 100.

Note that on the outside surface of the handle 101 there may be power a power switch 106. When actuated, the power switch 106 activates a motor (not shown) in the lower housing 121.

FIG. 2 is a sectional view of the hair-cutting device 100 where the head 102 is attached to the lower housing 121. Note that the head 102 shown in FIG. 1 and FIG. 2 is a clipper head, which is described further with reference to

The power switch 106 (FIG. 1) activates a rotary motor 203 of the lower housing 121. The motor 203 drives the head 102 when the switch 106 is activated.

The sensor 205 is electrically coupled to a printed circuit board (PCB) (not shown) in the lower housing 121. Operation is described further herein. The temperature sensor 205 senses the temperature of the blades in the head 102 and transmits data indicative of the temperature sensed to the PCB. Further, the sensor 205 is coupled to a heat pipe 204. The heat pipe 204 thermally contacts the head 102.

Note that in one embodiment, the lower housing 121 may comprise a fan (not shown). This fan may be coupled to the rotor of an additional motor (not shown). The fan can be activated based upon temperature readings from the sensor 205.

In operation, a barber switches on the hair-cutting device 100. The barber begins to cut a client's hair. While the head 102 is cuts, clips, or trims a client's hair, the temperature sensor 205 continuously or at a predetermined interval samples the temperature of the head 102 via the heat pipe 204. Data indicative of the temperature sensed is transmitted to the PCB.

Components on the PCB compare the data received indicative of the temperature from the sensor 205 to a threshold temperature. If the data indicative of the temperatures is greater than the threshold temperature, the PCB activates the fan.

FIG. 3 is a perspective view of the lower housing 121 of the hair-cutting device 100. The lower housing 121 comprises a contoured portion 605 for gripping. There is a lower shaft 601 that receives and couples to the head 102 (FIG. 1).

The lower housing 121 comprises a flat, top, circular surface 604. The flat circular surface 604 is adjacent the head 102 when the head 102 is affixed to the lower shaft 601. The circular surface 604 comprises a plurality of pinholes 602. In use, the fan (not shown) transmits air up through the plurality of pinholes 602, and the air cools the head 102.

The head 102 couples to the upper shaft 601. As will be described further herein, as the lower shaft 601 rotates, the rotation of the lower shaft 601 causes blades (not shown) to move in a linear direction thereby enables the head 102 to cut, trim, or clip hair of the client.

FIG. 4 is a perspective view of a clipper head 400 in accordance with an embodiment of the present disclosure. The clipper head 400 comprises a receptacle 401 for receiving the lower shaft 601 (FIG. 3). As the lower shaft 601 rotates, the blades 402 linearly move to clip a client's hair.

FIG. 5 is a perspective view of a trimmer head 500 in accordance with an embodiment of the present disclosure. The trimmer head 500 comprises a receptacle for receiving the lower shaft 601 (FIG. 3). As the lower shaft 601 rotates, the blades 502 linearly move to trim a client's hair.

The trimmer head 500 comprises an upper shaft 620. The lower shaft 601 fits into an opening 623 in a bottom of the upper shaft 620. The upper shaft 620 fits into an opening 624 in a blade yoke 622. The upper shaft 620 is mounted by a bearing collar 621 that holds a bearing 624 and the upper shaft 620.

In operation, the motor 203 (FIG. 2) transactionally coupled to the lower shaft 601 rotates the lower shaft 601. As the lower shaft 601 rotates, the upper shaft 620 rotates. As the upper shaft 620 rotates, the rotational movement is translated by the blade yoke 722 into linear movement of the blades 502 as the blade yoke 622 guides movement of the blades 502 during operation, translating rotation motion into linear motion. In this regard, the blade yoke 622 functions like a follower in a cam-follower mechanism translating rotational input into linear blade movement.

The upper shaft 620 is engaged with the opening 623 in the blade yoke 622. As the upper shaft 620 rotates, the blade yoke 622 translates the rotational movement into linear movement of the blades 502.

The trimmer head 500 comprises an upper shaft 720. The lower shaft fits 601 fits into an opening 723 in a bottom of the upper shaft 720. The upper shaft 720 fits into an opening in a blade yoke 722. The upper shaft 720 is mounted by a bearing collar 721 that holds a bearing 724 and the upper shaft 720.

In operation, the motor 203 (FIG. 2) transactionally coupled to the lower shaft 601 rotates the lower shaft 601. As the lower shaft 601 rotates, the upper shaft 720 rotates. As the upper shaft 720 rotates, the rotational movement is translated by the blade yoke 722 into linear movement of the blades 702 as the blade yoke 722 guides movement of the blades 702 during operation, translating rotation motion into linear motion. In this regard, the blade yoke 702 functions like a follower in a cam-follower mechanism translating rotational input into linear blade movement.

The upper shaft 720 is engaged with the opening 723 in the blade yoke 722. As the upper shaft 720 rotates, the blade yoke 722 translates the rotational movement into linear movement of the blades 702.

The upper shaft 620 or 720 comprises a generally cylindrical body 1001. In a bottom of the upper shaft 620/720 is an opening 623/723 for receiving the lower shaft 602. The upper shaft 620/720 comprises a generally cylindrical shaft projection 1002.

The shaft projection 1002 is situated a distance “d” from a center 1003 of a top surface of the cylindrical body 1002. The width of the blade throw desired for the type of haircut desired is dictated by the distance “d” of the shaft projection 1002 from the center 1003. In this regard, the greater “d” from the center 1003, the wider the blade throw induced in the blades 502 and 702.

1. A hair-cutting device, comprising:
a housing;
a lower shaft protruding from a top surface of the housing, the lower shaft configured for receiving a head, the top surface having pinholes configured for allowing air to exit the lower housing and strike the head.

2. The hair-cutting device, wherein the top surface is substantially flat.

3. The hair-cutting device, wherein the lower shaft is mechanically coupled to a motor, and when the motor is activated, the lower shaft actuates.

4. The hair-cutting device of claim 3, wherein the lower shaft actuates by rotating.

5. The hair-cutting device of claim 4, wherein the head comprises one or more blades coupled to a housing for clipping or trimming a person's hair.

6. The hair-cutting device of claim 5, wherein the head further comprises a receptacle for receiving the lower shaft.

7. The hair-cutting device of claim 6, wherein the head further comprises an upper shaft and the receptacle for receiving the lower shaft is an opening of a channel in the upper shaft.

8. The hair-cutting device of claim 7, wherein the head further comprises a blade yoke actuatingly coupled to the one or more blades.

9. The hair-cutting device of claim 8, wherein the blade yoke is configured for receiving the upper shaft.

10. The hair-cutting device of claim 9, wherein a coupling between the blade yoke and the upper shaft is configured such that when the upper shaft rotates, the blade yoke translates rotation of the upper shaft to linear displacement of the one or more blades.

11. The hair-cutting device of claim 1, wherein the head comprises one or more blades configured to clip hair.

12. The hair-cutting device of claim 11, wherein the uppers comprises a shaft projection coupled to a cylindrical body of the upper shaft at a distance such that the blade throw clips the hair.

13. The hair-cutting device of claim 1, wherein the head comprises one or more blades configured to trim hair.

14. The hair-cutting device of claim 13, wherein the upper shaft comprises a shaft projection coupled to a cylindrical body of the upper shaft at a distance such that the blade throw trims the hair.
